(19) United States
(12) Patent Application Publication
(10) Pub. No.: US 2019/0123333 A1
(43) Pub. Date: Apr. 25, 2019

(54) NONAQUEOUS ELECTROLYTE SECONDARY BATTERY POROUS LAYER

(71) Applicant: Sumitomo Chemical Company, Limited, Tokyo (JP)

(72) Inventor: Toshihiko OGATA, Osaka (JP)

(21) Appl. No.: 16/168,894

(22) Filed: Oct. 24, 2018

(30) Foreign Application Priority Data
Oct. 24, 2017 (JP) 2017-205596

(51) Int. Cl. H01M 2/16

(52) U.S. Cl. CPC H01M 2/1686; H01M 2/1673; H01M 2/1653

(57) ABSTRACT

The present invention achieves a nonaqueous electrolyte secondary battery having excellent air permeability. A nonaqueous electrolyte secondary battery porous layer in accordance with an aspect of the present invention includes a resin-containing lump-like region and a resin-containing chain-like region.

This Nonprovisional application claims priority under 35 U.S.C. § 119 on Patent Application No. 2017-205596 filed in Japan on Oct. 24, 2017, the entire contents of which are hereby incorporated by reference.

### TECHNICAL FIELD

The present invention relates to (i) a nonaqueous electrolyte secondary battery porous layer, (ii) a laminated separator for a nonaqueous electrolyte secondary battery (hereinafter referred to as “nonaqueous electrolyte secondary battery laminated separator”), (iii) a member for a nonaqueous electrolyte secondary battery (hereinafter referred to as “nonaqueous electrolyte secondary battery member”), and (iv) a nonaqueous electrolyte secondary battery.

### BACKGROUND ART

Nonaqueous electrolyte secondary batteries, particularly lithium ion secondary batteries, have a high energy density and are therefore in wide use as batteries for personal computers, mobile phones, portable information terminals, and the like. Such nonaqueous electrolyte secondary batteries have recently been developed as on-vehicle batteries.

As a member of such a nonaqueous electrolyte secondary battery, a separator having excellent heat resistance has been developed.

For example, Patent Literature 1 discloses a nonaqueous electrolyte secondary battery laminated separator including (i) a porous film and (ii) a porous layer made of an aramid resin which is a heat-resistant resin.

### CITATION LIST

### Patent Literature

[Patent Literature 1]

Japanese Patent Application Publication, Tokukai, No. 2001-23602 (Publication Date: Jan. 26, 2001)

### SUMMARY OF INVENTION

### Technical Problem

However, the above-described conventional nonaqueous electrolyte secondary battery, which includes a porous layer made of an aramid resin, has room for improvement in terms of air permeability.

Therefore, it is an object of an aspect of the present invention to achieve a nonaqueous electrolyte secondary battery having excellent air permeability.

### Solution to Problem

As a result of diligent study, the inventors of the present invention found that a nonaqueous electrolyte secondary battery porous layer, which has a region having a certain shape, has heat resistance and further excellent air permeability. The inventors of the present invention thus completed the present invention. Therefore, an aspect of the present invention encompasses the following [1] through [6].

<1> A nonaqueous electrolyte secondary battery porous layer including: a resin-containing lump-like region; and a resin-containing chain-like region.

<2> The nonaqueous electrolyte secondary battery porous layer described in <1>, in which at least one of the resin-containing lump-like region and the resin-containing chain-like region contains an aramid resin.

<3> The nonaqueous electrolyte secondary battery porous layer described in <1> or <2>, in which the resin-containing lump-like region and the resin-containing chain-like region contain a shared resin.

<4> A nonaqueous electrolyte secondary battery laminated separator including: a polyolefin porous film; and a nonaqueous electrolyte secondary battery porous layer described in any one of <1> through <3>, the nonaqueous electrolyte secondary battery porous layer being disposed on at least one surface of the polyolefin porous film.

<5> A nonaqueous electrolyte secondary battery member including: a positive electrode; a nonaqueous electrolyte secondary battery porous layer described in any one of <1> through <3> or a nonaqueous electrolyte secondary battery laminated separator described in <4>, and a negative electrode, the positive electrode, the nonaqueous electrolyte secondary battery porous layer or the nonaqueous electrolyte secondary battery laminated separator, and the negative electrode being arranged in this order.

<6> A nonaqueous electrolyte secondary battery including: a nonaqueous electrolyte secondary battery porous layer described in any one of <1> through <3> or a nonaqueous electrolyte secondary battery laminated separator described in <4>.

### Advantageous Effects of Invention

A nonaqueous electrolyte secondary battery porous layer in accordance with an aspect of the present invention advantageously has excellent air permeability.

### BRIEF DESCRIPTION OF DRAWINGS

FIG. 1 is a view illustrating an SEM image of a cross section of a nonaqueous electrolyte secondary battery porous layer in accordance with Embodiment 1.

### DESCRIPTION OF EMBODIMENTS

The following description will discuss an embodiment of the present invention. The present invention is, however, not limited to such an embodiment. Further, the present invention is not limited to the description of the arrangements below, but may be altered in various ways by a skilled person within the scope of the claims. Any embodiment based on a proper combination of technical means disclosed in different embodiments is also encompassed in the technical scope of the present invention. Any numerical range expressed as “A to B” herein means “not less than A and not more than B” unless otherwise stated.

[1. Nonaqueous Electrolyte Secondary Battery Porous Layer]

A nonaqueous electrolyte secondary battery porous layer in accordance with an embodiment of the present invention (hereinafter also simply referred to as “porous layer”) includes (i) a lump-like region containing a resin (a resin-containing lump-like region) and (ii) chain-like region containing a resin (a resin-containing chain-like region). A “porous layer” herein has a structure in which many pores, connected to one another, are provided, so that the porous layer is a layer through which a gas or a liquid can pass from one surface to the other.

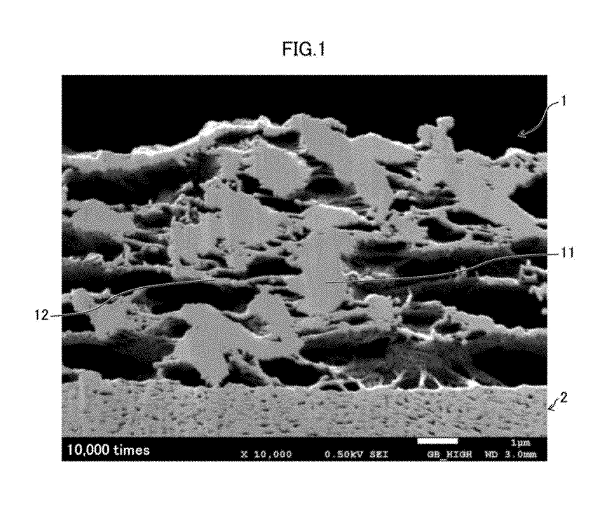

From an image obtained with use of a scanning electron microscope (SEM), it is possible to determine whether or not a porous layer includes a lump-like region and a chain-like region. FIG. 1 is a view illustrating an SEM image of a cross section of a porous layer obtained in Example 1 described later. In FIG. 1, a porous layer 1 is disposed on a polyolefin porous film 2. The cross section extends parallel to a direction in which a thickness of the porous layer extends. As indicated by FIG. 1, the porous layer 1 includes a lump-like region 11 and a chain-like region 12.

The lump-like region 11 is a region in the form of a lump, which region contains a resin. Because of the presence of the lump-like region 11, voids in the porous layer are properly secured. Therefore, a laminated separator including the porous layer has excellent air permeability and excellent ion permeability. The lump-like region 11 has an irregular shape, which can be a spherical shape. The lump-like region 11 can have a structure consisting of a single particle, or can have a structure in which a plurality of particles are aggregated.

The chain-like region 12 is a region in the form of a chain, which region contains a resin. Specifically, the chain-like region 12 is a region extending so as to be narrower than the lump-like region 11. The chain-like region 12 is to be connected to the lump-like region 11, and can have a linear shape or a branched shape.

The lump-like region 11 and the chain-like region 12 each contain a resin in an amount of typically not less than 50% by volume, preferably not less than 90% by volume, and more preferably not less than 95% by volume. The lump-like region 11 and the chain-like region 12 can each be made only of resin.

The lump-like region 11 and the chain-like region 12 can contain respective resins, or can contain a shared resin. In a case where the lump-like region 11 and the chain-like region 12 contain a shared resin, the lump-like region 11 and the chain-like region 12 are connected well to each other. This allows the shape of the porous layer to be further stable. The chain-like region 12 is preferably integrated with the lump-like region 11 so as to extend from the lump-like region 11. The chain-like region 12 is also preferably connected to a plurality of lump-like regions 11. This allows the shape of the porous layer to be further stable.

The resin is preferably a heat-resistant resin. Examples of the heat-resistant resin encompass: aromatic polyamides such as a wholly aromatic polyamide and a semi-aromatic polyamide; an aromatic polyimide; an aromatic polyamide imide; a polybenzimidazole; a polyurethane, and a melamine resin.

Among the heat-resistant resins above, aromatic polyamides such as a wholly aromatic polyamide and a semi-aromatic polyamide are preferable as the resin. Note that aromatic polyamides such as a wholly aromatic polyamide and a semi-aromatic polyamide are herein also referred to as “aramid resin”. Examples of the aramid resin encompass para-aramid and meta-aramid. Para-aramid is preferable.

Examples of a method of preparing the para-aramid encompass, but are not particularly limited to, condensation polymerization of para-oriented aromatic diamine and para-oriented aromatic dicarboxylic acid halide. In such a case, para-aramid to be obtained is substantially made up of repeating units in which amide bonds are bonded at para positions or corresponding oriented positions (for example, oriented positions that extend coaxially or parallel in opposite directions such as the cases of 4,4′-biphenylene, 1,5-naphthalene, and 2,6-naphthalene) of aromatic rings. Examples of the para-aramid encompass para-aramids each having a para-oriented structure or a structure corresponding to a para-oriented structure, such as poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and paraphenylene terephthalamide/2,6-dichloroparaphenylene terephthalamide copolymer. Among these, poly(paraphenylene terephthalamide) is preferable.

A solution of the poly(paraphenylene terephthalamide) (hereinafter referred to as “PPTA”) can be prepared by a specific method. Examples of such a specific method encompass a method including the following steps (1) through (4).

(1) N-methyl-2-pyrrolidone (hereinafter also referred to as “NMP”) is introduced into a flask which is dried. Then, calcium chloride, which has been dried at 200° C. for 2 hours, is added. Then, the flask is heated to 100° C. to completely dissolve the calcium chloride.
(2) A temperature of the solution obtained in the step (1) is returned to room temperature, and then paraphenylenediamine (hereinafter abbreviated as “PPD”) is added. Then, the PPD is completely dissolved.
(3) While a temperature of the solution obtained in the step (2) is maintained at 20±2° C., terephthalic acid dichloride (hereinafter referred to as “TPC”) is added in ten separate portions at approximately 5-minute intervals.
(4) While a temperature of the solution obtained in the step (3) is maintained at 20±2° C., the solution is matured for 1 hour, and is then stirred under reduced pressure for 30 minutes to eliminate air bubbles, so that the solution of the PPTA is obtained.

A solution containing particles of PPTA can be prepared by a specific method. Examples of the specific method encompass a method in which the solution of the PPTA obtained in the steps (1) through (4) above is stirred at 300 rpm and at 40° C. for 1 hour so that the particles of the PPTA are deposited.

Examples of a method of preparing the meta-aramid encompass, but are not particularly limited to, (1) condensation polymerization of (a) meta-oriented aromatic diamine and (b) meta-oriented aromatic dicarboxylic acid halide or para-oriented aromatic dicarboxylic acid halide and (2) condensation polymerization of (a) meta-oriented aromatic diamine or para-oriented aromatic diamine and (b) meta-oriented aromatic dicarboxylic acid halide. In such a case, the meta-aramid to be obtained includes a repeating unit in which amide bonds are bonded at meta positions or corresponding oriented positions of aromatic rings. Examples of the meta-aramid encompass poly(methaphenylene isophthalamide), poly(metabenzamide), poly(methaphenylene-4,4′-biphenylene dicarboxylic acid amide), poly(methaphenylene-2,6-naphthalene dicarboxylic acid amide), and a methaphenylene terephthalamide/2,6-dichloroparaphenylene terephthalamide copolymer.

Examples of the porous layer encompass: polyolefins such as polyethylene, polypropylene, polybutene, and an ethylene-propylene copolymer; fluorine-containing resins such as polyvinylidene fluoride (PVDF), polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, and an ethylene-tetrafluoroethylene copolymer; a fluorine-containing rubber having a glass transition temperature of equal to or less than 23° C., among the fluorine-containing resins; a polyamide-based resin; polyester-based resins such as aromatic polyester (e.g., polyarylate) and liquid crystal polyester; rubbers such as a styrene-butadiene copolymer and a hydride thereof, a methacrylic acid ester copolymer, an acrylonitrile-acrylic acid ester copolymer, a styrene-acrylic acid ester copolymer, ethylene propylene rubber, and polyvinyl acetate; resins with a melting point or glass transition temperature of not lower than 180° C. such as polyphenylene ether, polysulfone, polyether sulfone, polyphenylene sulfide, polyetherimide, polyamide imide, and polyether amide; and water-soluble polymers such as polyvinyl alcohol, polyethylene glycol, cellulose ether, sodium alginate, polyacrylic acid, polyacrylamide, and polymethacrylic acid.

The porous layer has a thickness of preferably 0.5 μm to 15 μm and more preferably 2 μm to 10 μm. In a case where the porous layer has a thickness of not less than 0.5 μm, it is possible to (i) sufficiently prevent a short circuit from occurring in a battery and (ii) allow an amount of electrolyte retained in the porous layer to be maintained. Meanwhile, in a case where the porous layer has a thickness of not more than 15 μm, it is possible to (i) restrict an increase in resistance to ion permeation, (ii) prevent a positive electrode from deteriorating in a case where a charge-discharge cycle is repeated and (iii) prevent a rate characteristic and a cycle characteristic from deteriorating. In addition, an increase in distance between the positive electrode and a negative electrode is restricted, so that the nonaqueous electrolyte secondary battery can be prevented from being large in size.

In view of adhesiveness of the porous layer to an electrode and ion permeability of the porous layer, a weight per unit area of the porous layer is, preferably 0.5 g/m² to 20 g/m², more preferably 0.5 g/m² to 10 g/m², and still more preferably 0.5 g/m² to 7 g/m², in terms of solid content.

<Method of Producing Porous Layer>

The porous layer can be produced by, for example, the following method. First, a solution, in which the above-described resin is dissolved in a solvent, is obtained. Then, the solution is heated or cooled, or a poor solvent is added to the solution. This produces a suspension in which part of the resin is deposited. Note that a resultant product obtained by the deposition of the resin is herein also referred to as “filler”. The suspension can be used as a coating solution for the formation of the porous layer. Alternatively, a coating solution can be prepared by adding a solution of the resin to the suspension. After a base material is coated with the coating solution thus obtained, the poor solvent is further added. This causes a dissolved resin, which is remaining in the solution, to be further deposited. Mainly, a lump-like region is formed by the filler, and a chain-like region is formed by a resin which had been remaining in the solution and was then deposited after the coating. Then, the solvent and the poor solvent are removed by drying or the like, so that a porous layer is formed.

Examples of the base material encompass a polyolefin porous film and an electrode (described later). Examples of the solvent encompass N-methylpyrrolidone, N,N-dimethylacetamide, and N,N-dimethylformamide.

A method of coating the base material with the coating solution encompass publicly known coating methods such as that in which a knife, a blade, a bar, a gravure, or a die is used. A method of removing the solvent is a typical drying method. Examples of the drying method encompass natural drying, air-blowing drying, heat drying, and drying under reduced pressure. Note, however, that any method can be used, provided that the solvent can be sufficiently removed. Examples of the poor solvent encompass a solvent having a low boiling point, such as water, alcohol, or acetone.

A porous layer in accordance with an embodiment of the present invention can contain a filler other than the lump-like region and the chain-like region. The filler can selected from an organic powder, an inorganic powder, or a mixture of an organic powder and an inorganic powder.

Examples of the organic powder encompass powders made of organic matter such as: (i) a homopolymer of a monomer such as styrene, vinyl ketone, acrylonitrile, methyl methacrylate, ethyl methacrylate, glycidyl methacrylate, glycidyl acrylate, or methyl acrylate or (ii) a copolymer of two or more of such monomers; fluorine-based resins such as polytetrafluoroethylene, ethylene tetrafluoride-propylene hexafluoride copolymer, ethylene tetrafluoride-ethylene copolymer, and polyvinylidene fluoride; melamine resin; urea resin; polyolefin; and polymethacrylate. Among these organic powders, a polytetrafluoroethylene powder is preferable in view of chemical stability.

Examples of the inorganic powder encompass powders made of inorganic matters such as metal oxide, metal nitride, metal carbide, metal hydroxide, carbonate, and sulfate. Specific examples of the inorganic powder encompass powders made of inorganic matters such as alumina, boehmite, silica, titanium dioxide, aluminum hydroxide, and calcium carbonate. Among these inorganic powders, an alumina powder is preferable in view of chemical stability. Each of those fillers can be used individually. Alternatively, two or more of those fillers can be used in combination.

[2. Nonaqueous Electrolyte Secondary Battery Laminated Separator]

A laminated separator for a nonaqueous electrolyte secondary battery in accordance with an embodiment of the present invention (hereinafter referred to as a “nonaqueous electrolyte secondary battery laminated separator” or simply referred to as “laminated separator”) includes (i) a polyolefin porous film and (ii) the above-described porous layer disposed on at least one surface of the polyolefin porous film. The porous layer can be a layer which, serving as an outermost layer of the laminated separator, comes into contact with an electrode. The porous layer can be disposed on one surface or both surfaces of the polyolefin porous film.

<Polyolefin Porous Film>

The polyolefin porous film can serve as a base material of the laminated separator. The polyolefin porous film has therein many pores connected to one another, so that a gas or a liquid can pass through the polyolefin porous film from one surface to the other.

The “polyolefin porous film” means a porous film containing a polyolefin-based resin as a main component. The expression that a “porous film contains a polyolefin-based resin as a main component” means that the polyolefin-based resin accounts for not less than 50% by volume, preferably not less than 90% by volume, and more preferably not less than 95% by volume, of the entire material constituting the porous film.

Examples of the polyolefin-based resin encompass a homopolymer and a copolymer, any of which is obtained through (co)polymerization of a monomer such as ethylene, propylene, 1-butene, 4-methyl-1-pentene, and 1-hexene (which are thermoplastic resins). Examples of the homopolymer encompass polyethylene, polypropylene, and polybutene. Examples of the copolymer encompass an ethylene-propylene copolymer. Among these, polyethylene is preferable because it is capable of preventing (shutting down) a flow of an excessively large electric current at a lower temperature.

The polyolefin porous film has a thickness of preferably 4 μm to 40 μm and more preferably 5 μm to 20 μm. In a case where the polyolefin porous film has a thickness of not less than 4 μm, it is possible to sufficiently prevent a short circuit in a battery. Meanwhile, in a case where the polyolefin porous film has a thickness of not more than 40 μm, it is possible to (i) restrict an increase in resistance to ion permeation, (ii) prevent a positive electrode from deterioration which occurs due to repetitive charge-discharge cycles, and (iii) prevent a rate characteristic and a cycle characteristic from deterioration which occurs due to repetitive charge-discharge cycles. In addition, an increase in size of the nonaqueous electrolyte secondary battery, which occurs due to an increase in distance between the positive electrode and a negative electrode, can be prevented.

The polyolefin porous film has a porosity of preferably 20% by volume to 80% by volume and more preferably 30% by volume to 75% by volume. In a case where the porosity falls within these ranges, it is possible to (i) retain a larger amount of an electrolyte and (ii) reliably prevent (shut down) a flow of an excessively large electric current at a lower temperature. In a case where the porosity is not less than 20% by volume, it is possible to restrict resistance of the polyolefin porous film to ion permeation. The porosity is preferably not more than 80% by volume in view of mechanical strength of the polyolefin porous film.

<Method of Producing Polyolefin Porous Film>

A method of producing the polyolefin porous film can be, for example, a method in which (i) a pore forming agent is added to a polyolefin-based resin so as to form a film and then (ii) the pore forming agent is removed with use of an appropriate solvent.

Specifically, in a case where, for example, a polyolefin-based resin, which contains ultra-high molecular weight polyethylene and low molecular weight polyolefin which has a weight-average molecular weight of not more than 10,000, is used, it is preferable in view of production costs that the polyolefin porous film is produced by a method including:

(1) kneading 100 parts by mass of ultra-high molecular weight polyethylene, 5 parts by mass to 200 parts by mass of low molecular weight polyolefin having a weight-average molecular weight of not more than 10,000, and 100 parts by mass to 400 parts by mass of a pore forming agent, so as to obtain a polyolefin resin composition; and
(2) forming the polyolefin resin composition into a rolled sheet by rolling,
(3) removing the pore forming agent from the rolled sheet obtained in the step (2);
(4) stretching the sheet obtained in the step (3), so as to obtain the polyolefin porous film.

Examples of the pore forming agent encompass an inorganic bulking agent and a plasticizer. Examples of the inorganic bulking agent encompass an inorganic filler. Examples of the plasticizer encompass a low molecular weight hydrocarbon such as liquid paraffin.

<Method of Producing Nonaqueous Electrolyte Secondary Battery Laminated Separator>

A method of producing the nonaqueous electrolyte secondary battery laminated separator in accordance with an embodiment of the present invention can be, for example, the above-described method of producing the porous layer in which polyolefin porous film is used as a base material which is coated with the coating solution.

[3. Nonaqueous Electrolyte Secondary Battery Member, Nonaqueous Electrolyte Secondary Battery]

A nonaqueous electrolyte secondary battery member in accordance with an embodiment of the present invention includes a positive electrode, the above-described porous layer or the above-described laminated separator, and a negative electrode such that the positive electrode, the porous layer or the laminated separator, and the negative electrode are arranged in this order. A nonaqueous electrolyte secondary battery in accordance with an embodiment of the present invention includes the above-described porous layer or the above-described laminated separator. The nonaqueous electrolyte secondary battery typically has a structure in which the negative electrode and the positive electrode face each other through the porous layer or the laminated separator. The nonaqueous electrolyte secondary battery is configured so that a battery element is enclosed in an exterior member, the battery element including (i) the structure and (ii) an electrolyte with which the structure is impregnated. For example, the nonaqueous electrolyte secondary battery is a lithium ion secondary battery which achieves an electromotive force through doping with and dedoping of lithium ions.

<Positive Electrode>

Examples of the positive electrode encompass a positive electrode sheet having a structure in which an active material layer including a positive electrode active material and a binder resin is formed on a current collector. The active material layer can further include an electrically conductive agent.

The positive electrode active material is, for example, a material capable of being doped with and dedoped of lithium ions. Examples of such a material encompass a lithium complex oxide containing at least one transition metal such as V, Mn, Fe, Co, or Ni.

Examples of the electrically conductive agent encompass carbonaceous materials such as natural graphite, artificial graphite, cokes, carbon black, pyrolytic carbons, carbon fiber, and a fired product of an organic polymer compound.

Examples of the binding agent encompass: thermoplastic resins such as polyvinylidene fluoride, a copolymer of vinylidene fluoride, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, a thermoplastic polyimide, polyethylene, and polypropylene; acrylic resin; and styrene butadiene rubber. Note that the binding agent also serves as a thickener.

Examples of the positive electrode current collector encompass electric conductors such as Al, Ni, and stainless steel. Among these, Al is preferable because Al is easily processed into a thin film and is inexpensive.

The positive electrode sheet can be produced by, for example, (I) a method in which pressure is applied to the positive electrode active material, the electrically conductive agent, and the binding agent on the positive electrode current collector to form a positive electrode mix thereon or (II) a method in which (i) an appropriate organic solvent is used so that the positive electrode active material, the electrically conductive agent, and the binding agent will be in a paste form to provide a positive electrode mix, (ii) the positive electrode mix is applied to the positive electrode current collector, (iii) the applied positive electrode mix is dried so that a sheet-shaped positive electrode mix is prepared, and then (iv) pressure is applied to the sheet-shaped positive electrode mix so that the sheet-shaped positive electrode mix is firmly fixed to the positive electrode current collector.

<Negative Electrode>

Examples of the negative electrode encompass a negative electrode sheet having a structure in which an active material layer including a negative electrode active material and a binder resin is formed on a current collector. The active material layer can further include an electrically conductive agent.

Examples of the negative electrode active material encompass (i) a material capable of being doped with and dedoped of lithium ions, (ii) a lithium metal, and (iii) a lithium alloy. Examples of the material encompass: carbonaceous materials such as natural graphite, artificial graphite, cokes, carbon black, pyrolytic carbons, carbon fiber, and a fired product of an organic polymer compound; chalcogen compounds such as an oxide and a sulfide that are doped with and dedoped of lithium ions at an electric potential lower than that for the positive electrode; metals such as aluminum (Al), lead (Pb), tin (Sn), bismuth (Bi), or silicon (Si), each of which is alloyed with alkali metal; cubic intermetallic compounds (AlSb, Mg₂Si, and NiSi₂) having lattice spaces in which alkali metals can be provided; and lithium nitrogen compounds (Li₃₋ₓMₓN (where M represents a transition metal)).

Examples of the negative electrode current collector encompass Cu, Ni, and stainless steel. Among these, Cu is preferable because it is not easily alloyed with lithium in the case of particularly a lithium-ion secondary battery and is easily processed into a thin film.

The negative electrode sheet can be produced, by, for example, (I) a method in which pressure is applied to the negative electrode active material on the negative electrode current collector to form a negative electrode mix thereon or (II) a method in which (i) an appropriate organic solvent is used so that the negative electrode active material will be in a paste form to provide a negative electrode mix, (ii) the negative electrode mix is applied to the negative electrode current collector, (iii) the applied negative electrode mix is dried so that a sheet-shaped negative electrode mix is prepared, and then (iv) pressure is applied to the sheet-shaped negative electrode mix so that the sheet-shaped negative electrode mix is firmly fixed to the negative electrode current collector. The above paste preferably includes the electrically conductive agent and the binding agent.

<Nonaqueous Electrolyte>

A nonaqueous electrolyte is, for example, a nonaqueous electrolyte prepared by dissolving a lithium salt in an organic solvent. Examples of the lithium salt encompass LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, and LiAlCl₄. It is preferable to use, among the above lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃.

Examples of the organic solvent encompass: carbonates such as ethylene carbonate, propylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and fluorine-containing organic solvents each prepared by introducing a fluorine group into any of the organic solvents described above. Among the above organic solvents, carbonates are preferable. A mixed solvent of a cyclic carbonate and an acyclic carbonate or a mixed solvent of a cyclic carbonate and an ether is more preferable. The mixed solvent of a cyclic carbonate and an acyclic carbonate is still more preferably a mixed solvent of ethylene carbonate, dimethyl carbonate, and ethyl methyl carbonate. This is because such a mixed solvent leads to a wider operating temperature range, and is not easily decomposed even in a case where a negative electrode active material is a graphite material such as natural graphite or artificial graphite.

<Nonaqueous Electrolyte Secondary Battery Member Production Method and Nonaqueous Electrolyte Secondary Battery Production Method>

The nonaqueous electrolyte secondary battery member can be produced by, for example, arranging the positive electrode, the above-described porous layer or the above-described laminated separator, and the negative electrode in this order.

Alternatively, the nonaqueous electrolyte secondary battery can be produced by, for example, as follows. First, a nonaqueous electrolyte secondary battery member is placed in a container which serves as a housing of the nonaqueous electrolyte secondary battery. Then, the container is filled with a nonaqueous electrolyte. Then, while pressure inside the container is being reduced, the container is hermetically sealed. This produces the nonaqueous electrolyte secondary battery.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss embodiments of the present invention in more detail by Examples. Note, however, that the present invention is not limited to these Examples.

<Measuring Method and Evaluating Method>

In each of Examples below, physical properties of a laminated porous film (laminated separator) were measured and evaluated by a method described below.

(1) Confirmation of Shape of Resin

A laminated porous film obtained in an Example was processed by an ion milling method with use of a cross section polisher (CP). This produced a flat cross section, which was then subjected to SEM observation (observation of a reflection electron image) at an acceleration voltage of 0.5 kV with use of a field emission scanning electrode microscope JSM-7600F, manufactured by JEOL Ltd. This produced an electron micrograph (SEM image) at a magnification of 10,000 times. Note that an SEM image obtained in Example 1 is shown in FIG. 1.

With use of the SEM image, it was checked whether or not a resin contains a lump-like region and a chain-like region.

(2) Dimensional Retention

A dimensional retention was measured with a heat resistance serving as an index. First, a test piece having a 5 cm×5 cm square shape was cut out from a laminated porous film. At a center of the test piece, a 4 cm×4 cm square was drawn by marking lines. This test piece was sandwiched between 2 sheets of paper, and was held in an oven at 150° C. for 1 hour. Then, the test piece was taken out of the oven, and dimensions of the marking lines of the square were measured. From the dimensions thus obtained, a dimensional retention was calculated. A method of calculating the dimensional retention is as follows. Note that the term “widthwise (TD)” indicates a direction which is perpendicular to a machine direction.

Widthwise (TD) dimensional retention (%)=W2/W1×100

where (i) Widthwise (TD) length of a marking line before heating and (ii) W2 is a widthwise (TD) length of a marking line after heating.

(3) Air Permeability as Measured Through Gurley Method (Sec/100 cc)

In conformity with a JIS P 8117, air permeability of the laminated porous film was measured with the use of a digital timer Gurley densometer manufactured by YASUDA SEIKI SEISAKUSHO, LTD.

<Aramid Filler Production Example>

(Aramid Polymerization Solution)

Poly(paraphenylene terephthalamide) was produced with use of a 500-mL separable flask having a stirring blade, a thermometer, a nitrogen in current canal, and a powder addition port. Specifically, 440 g of N-methyl-2-pyrrolidone (NMP) was introduced in the flask which had been sufficiently dried. Then, 30.2 g of calcium chloride powder, which had been vacuum-dried at 200° C. for 2 hours, was added. Then, the temperature was raised to 100° C. so that the calcium chloride powder was completely dissolved. The temperature of the resultant solution was returned to room temperature, and then 13.2 g of paraphenylenediamine was added. Then, the paraphenylenediamine was completely dissolved. While the temperature of the resultant solution was maintained at 20° C.±2° C., 23.47 g of terephthalic acid dichloride was added in 4 separate portions at intervals of approximately 10 minutes. Then, while the resultant solution was being stirred at 150 rpm and maintained at 20° C.±2° C., the solution was matured for 1 hour. This produced an aramid polymerization solution.

(Method of Preparing Solution Containing Aramid Filler)

The aramid polymerization solution obtained was stirred at 40° C. at 300 rpm for 1 hour so that poly(paraphenylene terephthalamide) was deposited. This produced a solution containing an aramid filler.

### Example 1

The solution containing the aramid filler, which was obtained in the production example, was used as a coating solution. A porous film made of polyethylene (having a thickness of 12 μm and a porosity of 41%) was coated with the coating solution by a doctor blade method. A laminated body, which was the resultant coated product, was rested in air at a temperature of 50° C. and at a relative humidity of 70% for 1 minute. In so doing, a small amount of poly(paraphenylene terephthalamide), which was dissolved in the coating solution so as to remain, was deposited, so that chain-like regions were formed. Then, a resultant coated film was cleaned by being immersed in ion exchange water. Then, the resultant product was dried in an oven at 70° C. This produced a laminated porous film (1) including a porous layer in accordance with an embodiment of the present invention and the porous film made of polyethylene, the porous layer and the porous film being disposed on each other. A weight per unit area of the porous layer in the laminated porous film (1) was 3.0 g/m². Physical properties of the laminated porous film (1) are shown in Table 1.

### Example 2

To 100 parts by mass of the aramid polymerization solution obtained in the production example, 10 parts by mass of aramid and 90 parts by mass of melamine resin particles (EPOSTAR S6 manufactured by Nippon Shokubai Co., Ltd.) were added. Then, NMP was further added so that a solid content concentration would account for 20% by weight. The resultant mixture was mixed by being stirred twice. Each time, the mixture was stirred at 2,000 rpm for 30 seconds at room temperature with use of a planetary centrifugal mixer, “AWATORI RENTARO” (registered trademark; manufactured by Thinky Corporation). This produced a coating material. A laminated porous film (2) was obtained as in Example 1 except that, as a coating solution, the coating material was used instead of the solution obtained in the production example, which solution contained an aramid filler. A weight per unit area of the porous layer in the laminated porous film (2) was 4.1 g/m². Physical properties of the laminated porous film (2) are shown in Table 1.

### Comparative Example 1

A laminated porous film (3) was obtained as in Example 1 except that, as a coating solution, the aramid polymerization solution obtained in the production example was used instead of the solution obtained in the production example, which solution contained an aramid filler. A weight per unit area of the porous layer in the laminated porous film (3) was 1.9 g/m². Physical properties of the laminated porous film (3) are shown in Table 1.

TABLE 1

| | Lump-like region | Dimensional | Air |
|---|---|---|---|
| | and chain-like | retention | permeability |
| | region | (%) | (sec/100 cc) |
| Example 1 | Yes | 73 | 241 |
| Example 2 | Yes | 78 | 218 |
| Comparative Example 1 | No | 95 | 692 |

Table 1 shows that the laminated porous films produced in Examples 1 and 2 each had a lowered air permeability. This indicates excellent ion permeability. In addition, the laminated porous films produced in Examples 1 and 2 each had a high dimensional retention. This indicates that excellent heat resistance was maintained. Meanwhile, the laminated porous film produced in Comparative Example 1 had high air permeability.

FIG. 1 further indicates that the porous layer 1 has lump-like regions 11 and chain-like regions 12. Note that the porous layer obtained in Example 2 has a structure similar to that of the porous layer obtained in Example 1. Meanwhile, the porous layer obtained in Comparative Example 1 did not have such a structure.

### INDUSTRIAL APPLICABILITY

A porous layer in accordance with an aspect of the present invention and a nonaqueous electrolyte secondary battery laminated separator including the porous layer each have excellent air permeability, and therefore can each be put to a wide range of use in the field of nonaqueous electrolyte secondary battery production.

### REFERENCE SIGNS LIST

1 Porous layer
2 Polyolefin porous film
11 Lump-like region
12 Chain-like region

1. A nonaqueous electrolyte secondary battery porous layer comprising:
a resin-containing lump-like region; and
a resin-containing chain-like region.

2. The nonaqueous electrolyte secondary battery porous layer as set forth in claim 1, wherein
at least one of the resin-containing lump-like region and the resin-containing chain-like region contains an aramid resin.

3. The nonaqueous electrolyte secondary battery porous layer as set forth in claim 1, wherein
the resin-containing lump-like region and the resin-containing chain-like region contain a shared resin.

4. A nonaqueous electrolyte secondary battery laminated separator comprising:
a polyolefin porous film; and
a nonaqueous electrolyte secondary battery porous layer recited in claim 1, the nonaqueous electrolyte secondary battery porous layer being disposed on at least one surface of the polyolefin porous film.

5. A nonaqueous electrolyte secondary battery member comprising:
a positive electrode;
a nonaqueous electrolyte secondary battery porous layer recited in claim 1; and
a negative electrode,
the positive electrode, the nonaqueous electrolyte secondary battery porous layer, and the negative electrode being arranged in this order.

6. A nonaqueous electrolyte secondary battery comprising:
a nonaqueous electrolyte secondary battery porous layer recited in claim 1.

7. A nonaqueous electrolyte secondary battery member comprising:
a positive electrode;
a nonaqueous electrolyte secondary battery laminated separator recited in claim 4; and
a negative electrode,
the positive electrode, the nonaqueous electrolyte secondary battery laminated separator, and the negative electrode being arranged in this order.

8. A nonaqueous electrolyte secondary battery comprising:
a nonaqueous electrolyte secondary battery laminated separator recited in claim 4.
